(19) United States
(12) Patent Application Publication
(10) Pub. No.: US 2006/0208112 A1
(43) Pub. Date: Sep. 21, 2006

(54) Spray head for electrohydrodynamic spray device and electrohydrodynamic sprayer system

(76) Inventors: Beverly A. Piatt, Columbus, OH (US); Maria C. Rigling, Dayton, OH (US); R Reade Harpham, Columbus, OH (US); Joseph A. Juratovac, Columbus, OH (US); M. Scott Ulrich, Columbus, OH (US); James E. Dvorsky, Norwich Township, OH (US); Songsdhit Chongsiriwatana, Orlando, FL (US)

Correspondence Address: BATTELLE MEMORIAL INSTITUTE, 505 KING AVENUE, COLUMBUS, OH, 43201-2693, US

(21) Appl. No.: 10/541,681

(22) PCT Filed: Jan. 10, 2004
(86) PCT No.: PCT/US04/00556

§ 371 Date: Apr. 12, 2006

Related U.S. Application Data
(60) Provisional application No. 60/439,254, filed on Jan. 10, 2003.
(60) Provisional application No. 60/439,257, filed on Jan. 10, 2003.
(60) Provisional application No. 60/439,606, filed on Jan. 11, 2003.

(51) Int. Cl. F23D 11/32; B05B 5/00

(52) U.S. Cl. 239/690; 239/690.1; 239/692

(57) ABSTRACT

A spray head for use with an electrohydrodynamic spray device is provided. The spray head comprises at least one nozzle and a shroud that at least partially surrounds the nozzle. The nozzle is configured to provide a charged aerosol from a liquid formulation. The nozzle comprises a manifold having at least one fluid entrance and one or more discrete fluid spray sites.

The present invention relates to the production of an aerosol by means of electrohydrodynamics, and a spray device for the application of the electrically charged particles of material so produced. More particularly, the invention relates to the application of chemical agents such as, for example, herbicides, fungicides, insecticides, acaricides, miticides, molluscicides, nematicides, rodenticides, plant-desiccants, plant-growth regulators, etc. (pesticides in general), to a target. There is a recognized need for improvements in electrohydrodynamic sprayer design.

The present invention meets the above-mentioned need by providing a spray head for an electrohydrodynamic spray device and an electrohydrodynamic sprayer system. Although the present invention is not limited to specific advantages or functionality, it is noted that the electrohydrodynamic sprayer system incorporates a variety of features, all of which contribute to one or more of the following categories: functionality, safety to the user and/or the environment, and ease of use. The system can be used in many market areas, due to its versatility and ability to spray a wide variety of formulations. Because the flow rate of the system is controlled during a particular application, the dosage applied to the target is also very controlled, leading to efficiency in application.

The spray head can shape and/or direct the spray of liquid drops and therefore provides for more controlled and predictable application of electrically charged particles of a liquid formulation. The spray head can also protect the spray during applications under windy conditions and is effective in shielding human operators of the device from contact with the sprayed drops, as well as from direct contact with the spray nozzle at any time during operation of the device. In addition, the spray head can be configured to control the distance to the spray target. The nozzle creates a very focused and directed spray. Accordingly, when used to spray a form of targeted vegetation such as, for example, a weed, with a liquid formulation (for example, a herbicide), the liquid drops effectively cover the stems and underside of plant leaves due to the fact that the aerosol possesses an electrical charge.

In accordance with one embodiment of the present invention, a spray head for use with an electrohydrodynamic spray device is provided comprising at least one nozzle and a shroud. The nozzle comprises a manifold having at least one fluid entrance and one or more discrete fluid spray sites. The nozzle is configured to provide a charged aerosol of a liquid formulation. The shroud at least partially surrounds the nozzle and can be configured to physically direct the charged aerosol towards a target.

In accordance with another embodiment of the present invention, an electrohydrodynamic sprayer system is provided comprising means for delivering a charged aerosol by electrohydrodynamic components. The system is completely portable and may be comprised of the following components: a control panel, a power source, a pumping mechanism, a fluid container/cartridge, a nozzle, and a spray head.

These and other features and advantages of the invention will become apparent from the accompanying drawings and detailed description of the various embodiments.

The following detailed description of the embodiments of the present invention can be best understood when read in conjunction with the following drawings, where like structure is indicated with like reference numerals and in which:

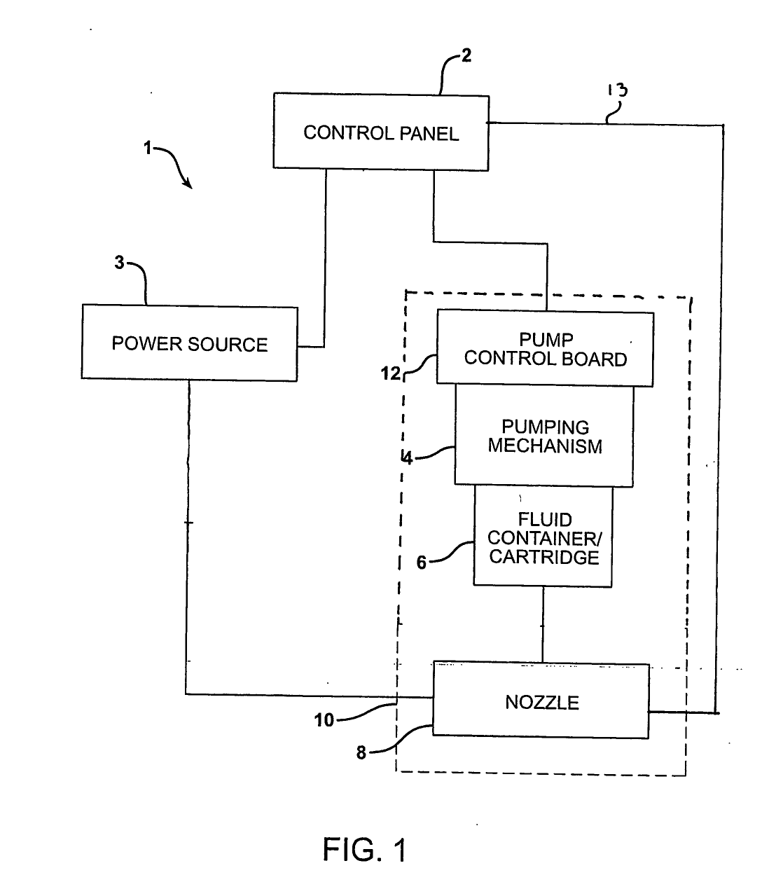

FIG. 1 is a schematic block diagram showing some of the different components that make up an electrohydrodynamic spray device in accordance with one embodiment of the present invention;

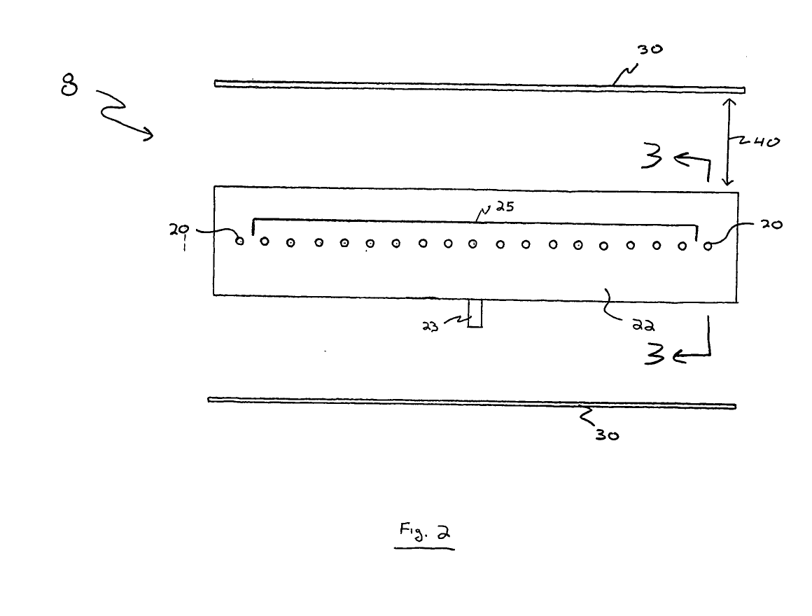

FIG. 2 shows a front plan view of a nozzle for an electrohydrodynamic spray device in accordance with the present invention;

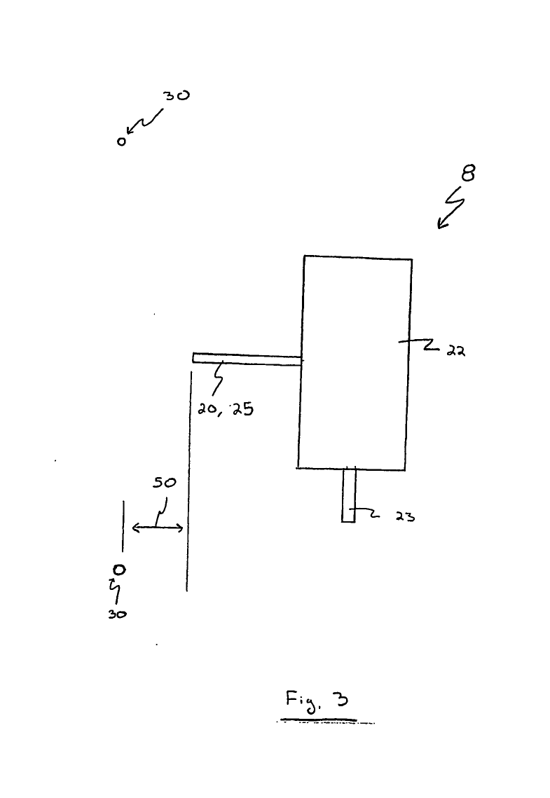

FIG. 3 shows a side plan view of a nozzle for an electrohydrodynamic spray device in accordance with the present invention;

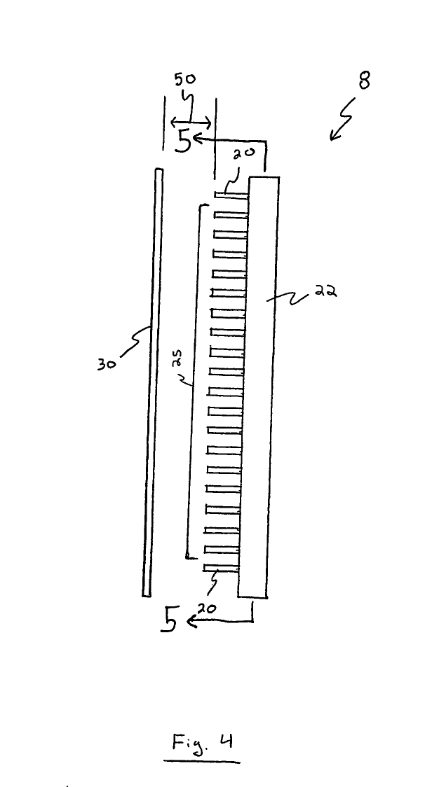

FIG. 4 shows a top plan view of a nozzle for an electrohydrodynamic spray device in accordance with the present invention;

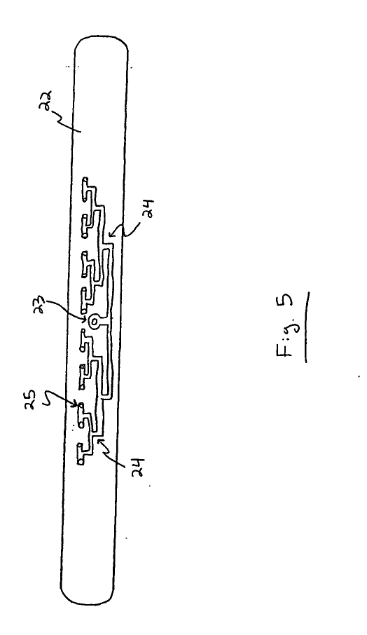

FIG. 5 is a schematic illustration of a manifold for an electrohydrodynamic spray device in accordance with the present invention;

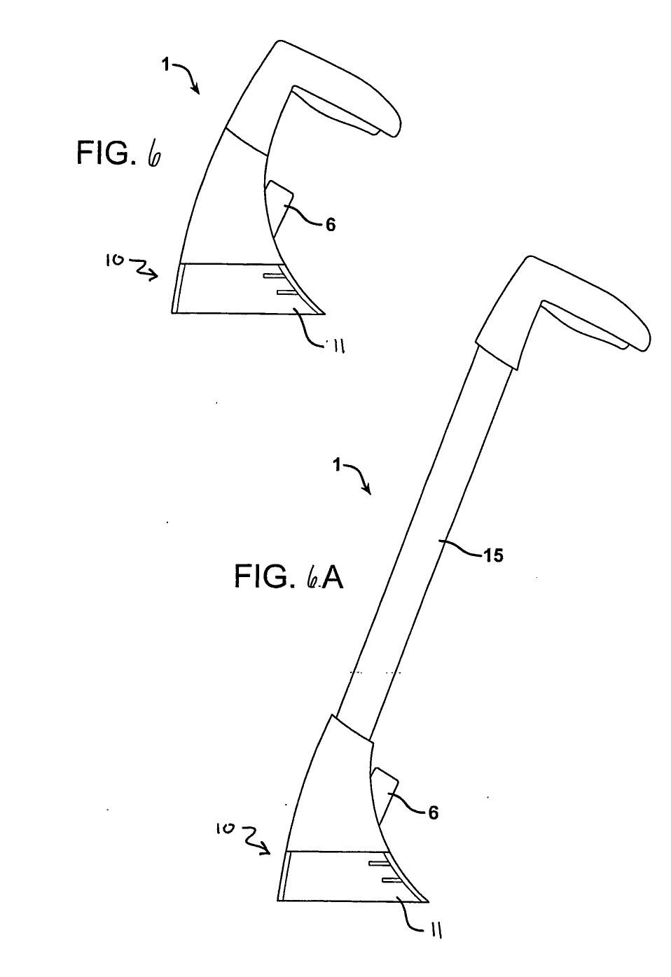

FIGS. 6 and 6A show schematic side views of an electrohydrodynamic spray device that includes a removable or collapsing telescopic portion and a spray head in accordance with another embodiment of the present invention.

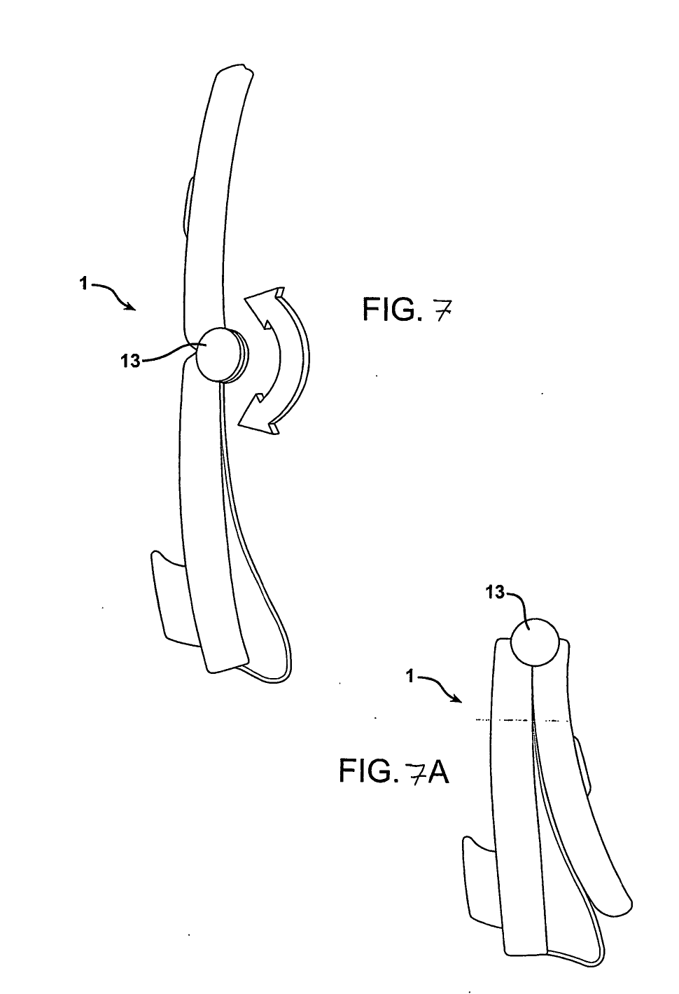

FIGS. 7 and 7A show schematic side views of an electrohydrodynamic spray device including a foldable portion and spray head in accordance with still another embodiment of the present invention;

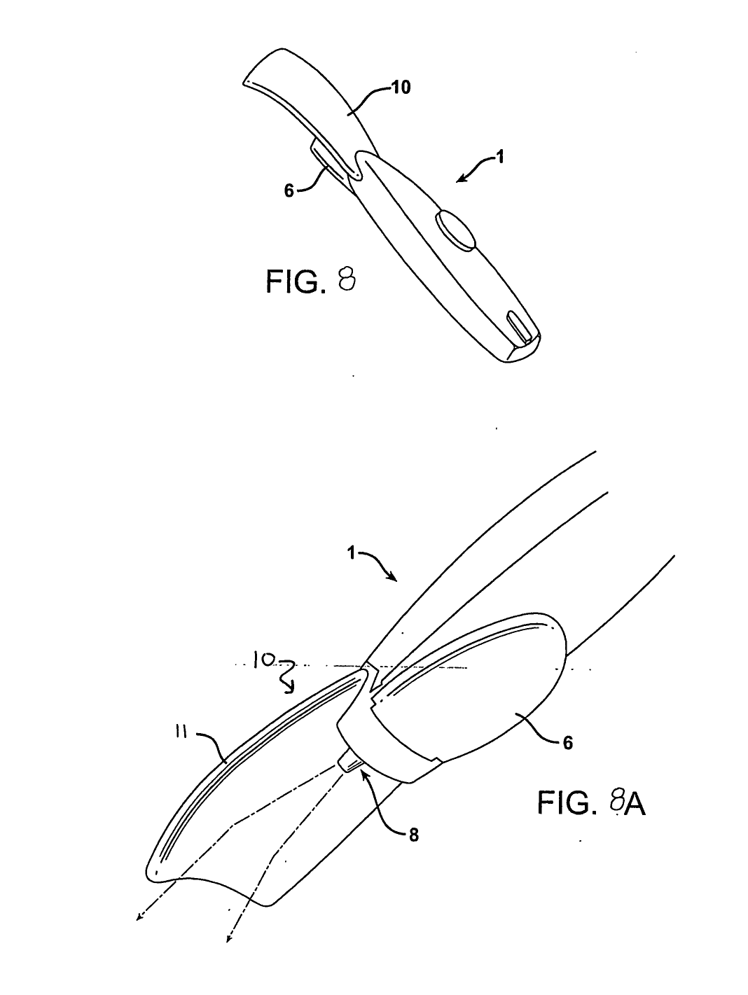

FIGS. 8 and 8A show schematic perspective views of an electrohydrodynamic spray device that includes a spray head in accordance with yet another embodiment of the present invention;

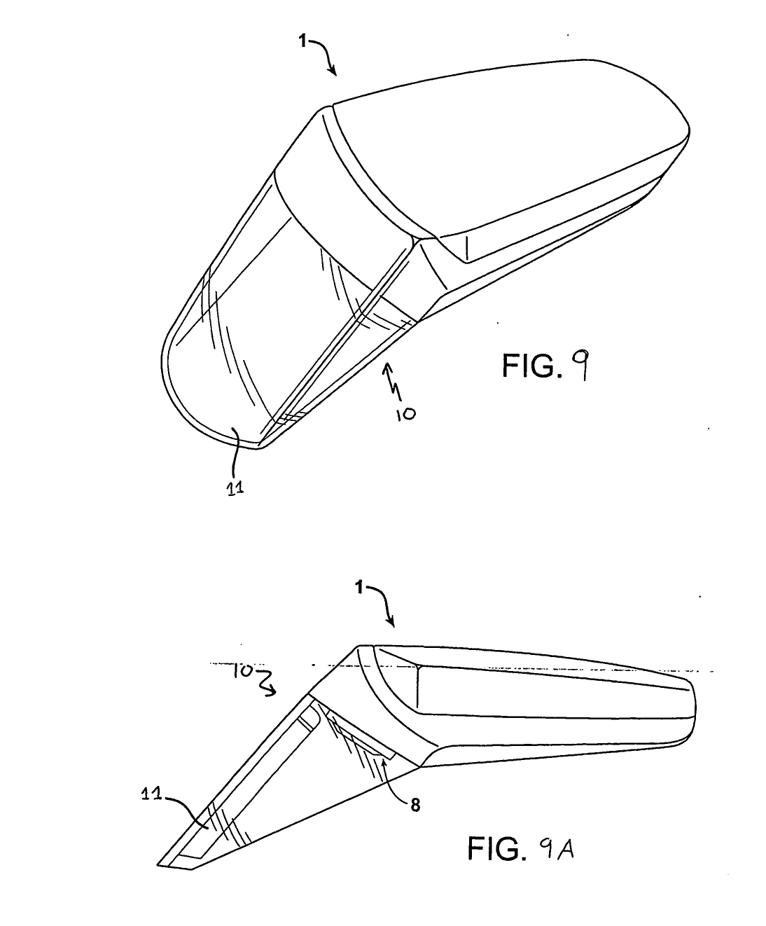

FIGS. 9 and 9A show a schematic perspective and side view, respectively, of an electrohydrodynamic spray device that includes a spray head in accordance with still yet another embodiment of the present invention;

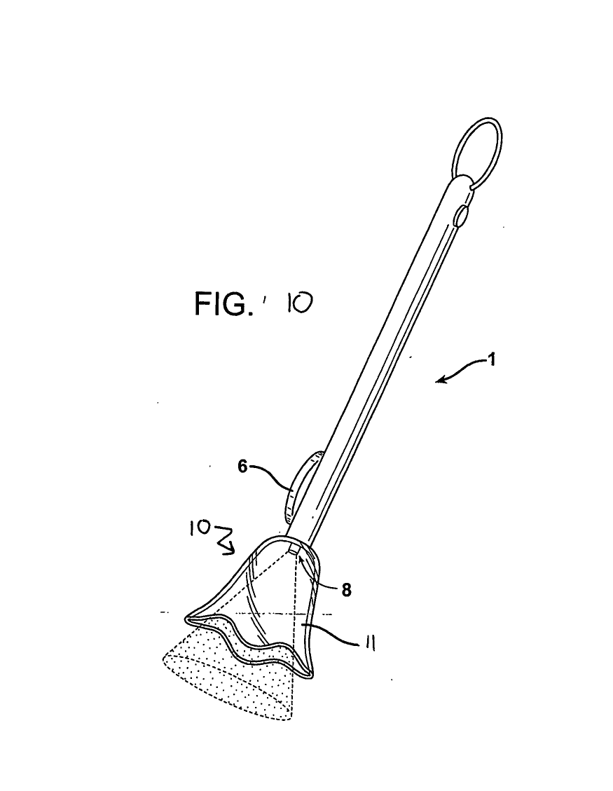

FIG. 10 shows a schematic perspective view of an electrohydrodynamic spray device that includes a spray head in accordance with still yet another embodiment of the present invention;

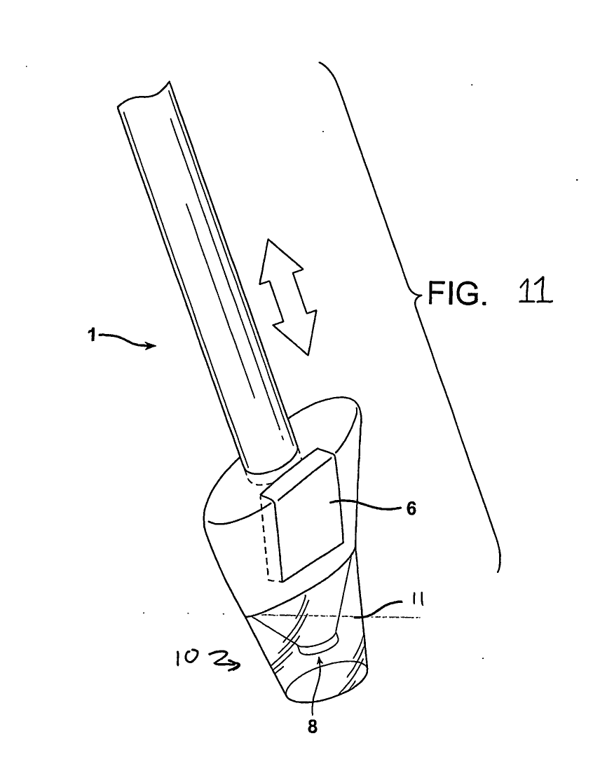

FIG. 11 shows a schematic perspective view of an electrohydrodynamic spray device that includes a spray head in accordance with still yet another embodiment of the present invention;

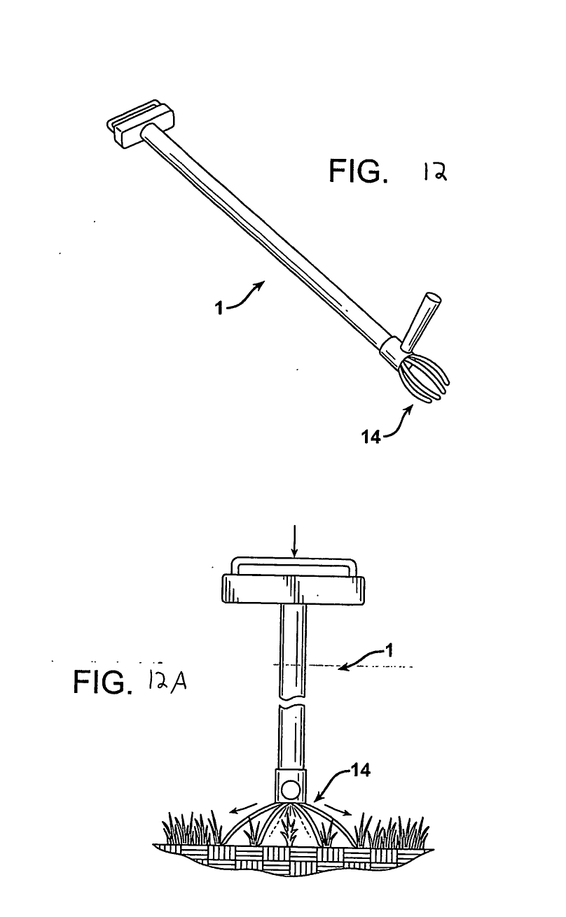

FIGS. 12 and 12A show a schematic perspective and side view, respectively, of an electrohydrodynamic spray device that includes a spray head defining a spreading tip, tines, or skirt for separating surrounding vegetation from a target weed or plant in accordance with still yet another embodiment of the present invention;

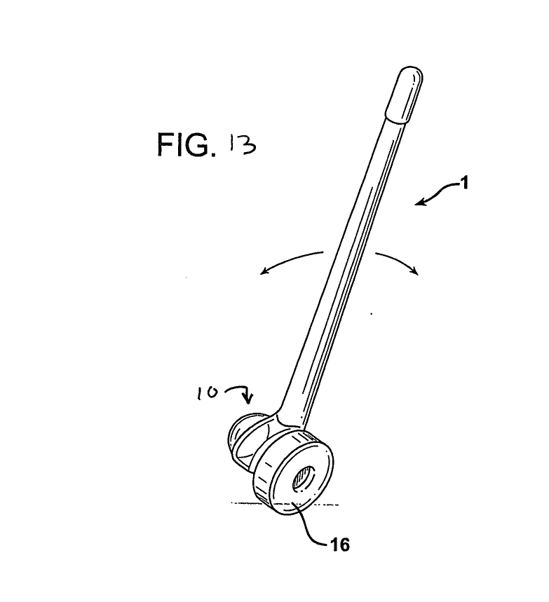

FIG. 13 shows a schematic perspective view of an electrohydrodynamic spray device that defines a wheel in accordance with still yet another embodiment of the present invention; and

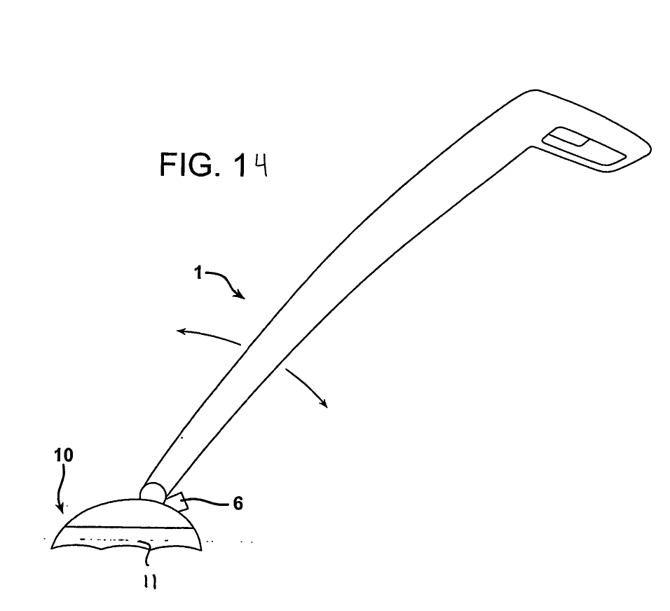

FIG. 14 shows a schematic side view of an electrohydrodynamic spray device that includes a rotating/swiveling spray head in accordance with still yet another embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiment(s) of the present invention.

Referring initially to FIG. 1, a schematic block diagram of an electrohydrodynamic spray device 1 is illustrated. In accordance with one exemplary embodiment of the present invention, the device 1 can comprise the following components: a control panel 2, a power source 3, a pumping mechanism 4, a fluid container/cartridge 6, a nozzle 8, and a spray head 10. Reference is made to the following commonly assigned PCT International Patent Application entitled “FLUID CONTAINER FOR ELECTROHYDRODYNAMIC SPRAY DEVICE AND METHOD OF USING SAME” (Attorney Docket No. BAT 0078 PB/40078.255), which further describes the components making up the device 1, the disclosure of which is incorporated herein by reference. The components can be connected by a plurality of electrical and mechanical interfaces. The device 1 can be configured to be portable and effectively provides a charged aerosol of a liquid formulation by means of electrohydrodynamics.

The control panel 2 provides an interface between the device 1 and the operator of the device 1 and can comprise one or more electrical switches for the power supply 3 and pump 4, as well as several warning LEDs for low battery and high voltage power, inter alia. The power source 3 can comprise one or more batteries, and can be configured to convert low DC voltage to the high DC voltage that is needed for aerosolization. By “high” DC voltage, we mean voltage in the kilovolt range. The fluid container/cartridge 6 can define a removable reservoir that is positioned within the device 1 and can contain a volume of a liquid formulation. The fluid container/cartridge 6 is in fluid communication with the pumping mechanism 4 and the nozzle 8. Alternatively, the fluid container 6, pumping mechanism 4, pump control board 12, nozzle 8, or combinations thereof can be assembled or included as a unit as part of the spray head 10. In any event, the pumping mechanism 4 is configured to pump a volume of liquid formulation from the fluid container/cartridge 6 to the nozzle 8 at a controlled flow rate, and can comprise a motion control circuit board and a DC motor (not shown), inter alia. The flow rate of the pumping mechanism 4 can be controlled by a pump control board 12. The liquid formulation can contain an active ingredient, such as a pesticidal or herbicidal compound.

The high voltage provided by the power source 3, pumping flow rate by way of the pump control board 12, and application time are all easily adjustable on the device 1. The device 1, in response to certain preset specifications for spraying a particular liquid formulation, can make adjustments automatically. This feature contributes to the ease of use of the device 1. As such, the device 1 can further comprise a container/contents recognition feedback loop 13, which enables the passage of data via electrical signals from the container 6 to the control board 2. The user of the device 1 can also make adjustments manually. Accordingly, due to its versatility and ability to spray a wide variety of formulations, a single device 1 can be used for a wealth of different applications. For example, the device 1 can be employed for applying a pesticide to a particular target plant or animal. Since the flow rate of the formulation is controlled during a particular application, the dosage applied to the plant or animal is also very controllable, which provides for efficiency in application. Moreover, in order to configure the device 1 so that it is comfortable to use for a variety of people, as well as configured to spray a variety of sizes of plants, the size of the device 1 can also be adjustable. For example, the device 1 can be converted from a long stand-up or stick-like configuration (see FIG. 6A) to that of hand-held proportions (see FIG. 6). This conversion of the device 1 can be accomplished by many means, including folding about a rotatable joint 13 (see FIGS. 7 and 7A), removing an extension piece 15 (see FIGS. 6 and 6A), or collapsing a telescopic portion (not shown).

Referring now to FIGS. 2-5, in accordance with the present invention, a spray head for use with an electrohydrodynamic spray device is provided, and the spray head comprises a nozzle 8. The nozzle 8 is configured to provide a charged aerosol from a liquid formulation and comprises a manifold 22 having at least one fluid entrance 23 and one or more discrete fluid exits or fluid spray sites 25. The fluid spray sites 25 are typically arranged in a linear array. However, fluid spray sites 25 of different configurations are also contemplated and are intended as being within the scope of the present application such as, for example, an arched or non-linear series of fluid spray sites, or a circular array of fluid spray sites 25.

The nozzle 8 that is defined by the electrohydrodynamic spray device 1 of the present invention is configured to create a charged aerosol of a liquid formulation by causing the liquid to flow over a region of high electric field strength. The region of high electric field strength can be provided by a charged electrode, which is in communication with the fluid spray sites 25, and which provides the liquid formulation with a net electric charge. The charge tends to remain on the surface of the liquid such that, as the liquid exits the nozzle 8, the repelling force of the surface charge balances against the surface tension of the liquid, forming a Taylor cone. The electrical force exerted on the liquid surface overcomes the surface tension at the tip of the cone, generating a thin jet of liquid. Preferably, this jet breaks into droplets of more or less uniform size, which collectively form an aerosol of charged liquid. However, it should be understood that the jet could produce particles, such as, solid, partially solid, and gel-like droplets; fibers; fibrils, semisolids; and capsules, etc.

The nozzle 8 that is defined by the present application is effective in forming a charged aerosol of numerous formulations at a controlled flow rate and predictable spray pattern. The liquid formulation can have a wide range of physical properties and still remain sprayable such as, for example, a resistivity between about 100 and about 5,000,000 Ohm-m and a viscosity between about 0.8 and about 590 cP. Moreover, the liquid formulation can contain an active ingredient, such as a pesticidal or herbicidal compound.

In accordance with another embodiment of the present invention, the nozzle 8 can comprise a manifold 22 having one fluid entrance 23 and one or more discrete fluid exits or fluid spray sites 25 with equidistant passages 24 in fluid communication with the fluid spray sites 25 (see FIG. 5). Accordingly, fluid traveling within the manifold 22 covers an equal distance from the fluid entrance 23 to any of the one or more fluid spray sites 25. The fluid spray sites 25 can be arranged in a linear array and are in communication with a charged electrode. However, the manifold 22 of the instant embodiment having equidistant passages 24 allows for fluid spray site arrays of different geometric shapes and orientations, passages of different lengths, shapes, or effective diameters, including a portable device, while still maintaining equal flow of a liquid formulation to each discrete fluid spray site 25. This aspect of the present invention enables steady electrohydrodynamic spraying of a liquid formulation as certain applications requiring a delivered volume or rate of a liquid formulation can only be obtained from multiple fluid spray sites 25. Moreover, the instant embodiment allows for a very wide range of flow rates since flow restrictions for low flow rates can be designed into the passages 24, if required, and thus allows for scale up of a single nozzle 8 to any number of nozzles 8. Multiple nozzles 8 can be employed for spraying multiple fluid formulations from a single electrohydrodynamic spray device 1. The passages 24 can be configured so that they are deep enough to allow a more viscous fluid formulation to be sprayed by maintaining backpressure with a standard pumping device.

The manifold 22 of the instant embodiment can be configured so that there are at least one discrete fluid exits or fluid spray sites 25 for each final passage 24. The number of exits per fluid exit trough can be designed to accommodate the requisite number of exits. This allows the fluid formulation to be distributed at an even flow rate to discrete exits, which provides stability of Taylor cone formation and enables the formation of a more controlled and predictable aerosol.

In accordance with yet another embodiment of the present invention, the nozzle 8 comprises a spray shaping mechanism that defines directing electrodes 20 positioned equidistant at opposite ends of the one or more fluid spray sites 25, which fluid spray sites 25 can be arranged in a linear array. The directing electrodes 20 are charged at the same polarity and voltage as the fluid spray sites 25. This feature provides certain manufacturing advantages do to the fact that the same power supply can be used for both the directing electrodes 20 and the fluid spray sites 25. However, unlike the fluid spray sites 25 no fluid is passed through the directing electrodes 20. The directing electrodes 20 stabilize the Taylor cones and fluid spray sites 25 at the ends of the linear array and keep the aerosol directed forward rather than to the sides. Accordingly, the directing electrodes 20 are effective in producing a charged aerosol that is more uniform from the ends to the center of the linear array of fluid spray sites 25.

In accordance with still another embodiment of the present invention, the nozzle 8 comprises a spray shaping mechanism that defines parallel counter electrodes 30. The parallel counter electrodes 30 can be employed in localizing the electric field that is produced by the nozzle 8 for spraying a charged aerosol. Depending on the position of the counter electrodes 30 relative to the one or more fluid spray sites 25, the counter electrodes 30 can effectively boost the velocity of the electrohydrodynamic spray forward, as well as shape or split the spray toward a desired target. Accordingly, the counter electrodes 30 provide a shaping and/or propelling effect for the aerosol. The counter electrodes 30 further allow for both high and low nozzle density in a linear array of fluid spray sites 25. This feature of the instant embodiment presents a more uniform field to each fluid spray site 25, independent of the spray site's position within the nozzle 8. Moreover, the parallel counter electrodes 30 when combined with the linear array of fluid spray sites 25 provide more stable electrohydrodynamic spray and Taylor cone formation of a liquid formulation, independent of the distance between the nozzle 8 and the grounded target.

The counter electrodes 30 comprise thin rods that are arranged in parallel with and straddle the one or more fluid spray sites 25, which fluid spray sites 25 can be arranged in a linear array. The combination of vertical and horizontal positioning of the parallel counter electrodes 30 in relation to the array of fluid spray sites 25 effectively provides for directional spraying and provides for variations in the aerosol spray shape. The distance vertically 40 (see FIG. 2) and horizontally 50 (see FIGS. 3 and 4) from the counter electrodes 30 to the one or more fluid spray sites 25 assists in shaping the Taylor cone formation, thus allowing a propelling effect when positioned in front or out from the tip of the nozzle 8, and a splitting of the spray when the counter electrodes 30 or rods are placed closer to the tip of the nozzle 8. Accordingly, the counter electrodes 30 can be employed to shape the charged aerosol so that it reaches and covers a specified target. The spray shaping mechanism of the present invention, as described above, enables more efficient and targeted placement of a sprayed formulation to a target in order to affect a desired biological or other outcome. As such, less active ingredient is required.

In accordance with still yet another embodiment of the present invention, the nozzle 8 can optionally comprise a manifold 22 having one fluid entrance 23 and one or more discrete fluid exits or fluid spray sites 25 with equidistant passages 24 in fluid communication with the fluid spray sites 25, which fluid spray sites 25 can be arranged in a linear array, and a spray shaping mechanism that defines both directing electrodes 20 positioned equidistant at opposite ends of the fluid spray sites 25, and parallel counter electrodes 30 that comprise thin rods that are arranged in parallel with and straddle the one or more fluid spray sites 25. The directing electrodes 20 are charged at the same polarity and voltage as the fluid spray sites 25, and the counter electrodes 30 form a stable electric field at the fluid spray sites 25 which can propel the spray forward or shape the spray so that it comes in contact with a particular target. Each of the elements making up this nozzle 8 are described with particularity herein. The instant embodiment is a combination of all of these elements in a single nozzle 8 for an electrohydrodynamic spray device 1. Accordingly, the nozzle 8 of this embodiment of the present invention can be configured to produce a charged aerosol that is designed to come in contact with a variety of target shapes and sizes.

In accordance with the present invention, the spray head 10 also comprises a shroud 11 that can be comprised of a dielectric material. By “shroud” we mean a cover, guard or hood that surrounds or partially surrounds the nozzle 8. Typically, the dielectric material will comprise a polymeric material, such as, for example, a thermoplastic polymer that can be formed into any desired configuration. The dielectric material can be either transparent or opaque. Moreover, the dielectric material can be pigmented, such that the shroud 11 defines, for example, a translucent yellow material. Because the shroud 11 is comprised of a dielectric material and is essentially electrically non-conductive, the electrostatically charged liquid droplets expelled from the nozzle 8 will not be attracted to the shroud 11. Consequently, the spray head 10 or shroud 11 itself can act as a mechanism to shape the sprayed liquid formulation. For example, as illustrated by the arrows in FIG. 8A, the atomized liquid from the nozzle 8 can be directed against an inner surface of a shroud 11, thus shaping and/or directing the spray. Moreover, it is contemplated that the device 1 can define a hand-held embodiment with a half shroud 11 (see FIGS. 8 and 8A; 9 and 9A). In these embodiments, the fluid container/cartridge 6 can be located within the handle and the trigger that activates the electrohydrodynamic spraying function can be located either beneath or above the handle.

In accordance with still another embodiment, the spray head 10 can further define one or more elements that attract and/or shape the spray by spreading it out. These elements could be mounted directly to the spray head 10, preferably on the inside of the shroud 11. This feature provides more effective application of an aerosol to the target.

As illustrated in FIGS. 10 and 11, in accordance with yet another embodiment of the present invention, the shroud 11 can be configured to extend beyond the nozzle 8, such that the spray is shielded during application on a target plant or animal under windy conditions. In addition, the shroud 11 can be elongated to provide a path for the spray to traverse and may extend substantially to the ground or other point of desired application, such as, for example, a target plant or animal. Accordingly, the elongated shroud 11 can serve to protect both an operator of the device 1 and any bystander(s) from unwanted contact with the sprayed liquid formulation, as well as from touching the spray nozzle 8 at any time during operation of the device 1. These features can serve to address certain safety considerations do to the fact that the device 1 can be used to apply concentrated doses of chemical formulations that can be potentially hazardous or toxic to humans and other animals, and because the high voltage applied in atomizing the liquid formulation is also potentially hazardous should one touch the nozzle 8 while the device 1 is in operation. Moreover, the instant embodiment effectively delivers a dose of atomized liquid formulation to a target without it being applied to the surrounding area, thus providing more direct and efficient spraying of a target while imposing less impact on the environment.

In accordance with still yet another embodiment of the present invention, the device 1 may include a sensor (not shown), such as a “kill-switch”, which can be secured to the spray head 10 and is configured to prevent the device 1 from spraying if it is placed in an improper orientation. For example, if a user of the device 1 happens to turn the device 1 either partially or completely upside down, such that the nozzle 8 is inverted or otherwise pointed toward the user instead of the target plant or animal, the sensor can be configured to detect the orientation of the spray head 10 and prevent the discharge of spray. Accordingly, for example, this particular aspect of the present invention would prevent the accidental discharging of spray from the nozzle 8 should an operator of the device 1 invert and look into its interior. The instant embodiment therefore further contributes to the functionality and/or safety features of the present invention.

Referring now to FIGS. 12 and 12A, in accordance with still yet another embodiment of the present invention, the shroud 11 can optionally include a spreading tip, tines, or skirt 14 that is configured to separate desirable vegetation (such as, for example, turf grass) from the target vegetation (such as, for example, a weed). The device 1 can be configured so that activating the device 1 both spreads the surrounding vegetation from the target and delivers a sprayed dose. Thus, in use, a dose of atomized liquid formulation could be delivered to the target without it being applied to the adjacent vegetation, thus providing more direct and efficient spraying of a target while imposing less impact on the environment. The spreading tip, tines, or skirt 14 can be comprised of a dielectric or plastic material such that it does not attract the electrostatically charged droplets that are expelled from the nozzle 8. Moreover, the spreading tip, tines or skirt 14 can either be formed as a single unit together with the spray head 10 or as an attachment thereto, which could be removed and the device 1 used for other applications. Accordingly, the spreading tip, tines or skirt 14 further add to the multifunctional features of the present invention.

As illustrated in FIG. 13, in accordance with still yet another embodiment of the present invention, the spray head 10 can also optionally include a wheel 16 or other rotary device that can be configured to aid an operator in quickly and easily moving the spray device 1 from one location to another. In addition, the wheel 16 or other rotary device may be sized to control the distance of the spray head 10 and/or nozzle 8 above a target. Moreover, the wheel 16 or other rotary device could be employed in delivering an atomized liquid formulation along a defined boundary, such as, for example, a barrier between a walkway and lawn or flowerbed.

In still yet another embodiment, as illustrated in FIG. 14, the spray head 10 can be mounted onto the spray device 1 such that it is capable of rotating about one or more axes. Accordingly, the spray head 10 can be configured to provide easy adjustment for spraying a variety of targets of different sizes and shapes.

While the invention has been described by reference to certain preferred embodiments, it should be understood that numerous changes could be made within the spirit and scope of the inventive concepts described. This includes modification to the embodiment shown in sketches from hand-held devices to other configurations which include but are not limited to boomed devices pulled behind tractors, stationary-frames used to place a plant in to treat, and devices integrally installed in green-houses/glass-houses devices. Accordingly, it is intended that the invention not be limited to the disclosed embodiments, but that it have the full scope permitted by the language of the following claims:

1. A spray head for use with an electrohydrodynamic spray device, wherein said spray head comprises
at least one nozzle configured to provide a charged aerosol from a liquid formulation, said nozzle comprising a manifold having at least one fluid entrance and one or more discrete fluid spray sites; and
a shroud that at least partially surrounds said nozzle.

2. The spray head of claim 1, wherein said fluid spray sites are arranged in a linear array, non-linear array, or combination thereof.

3. The spray head of claim 1 further comprising a charged electrode in communication with said fluid spray sites.

4. The spray head of claim 1, wherein said manifold further comprises one or more equidistant passages in fluid communication with said fluid spray sites.

5. The spray head of claim 4, wherein fluid traveling within said manifold covers an equal distance from said fluid entrance to any one of said fluid spray sites.

6. The spray head of claim 4, wherein said manifold comprising equidistant passages allows for fluid spray site arrays of different geometric shapes and orientations, while maintaining equal flow of a liquid formulation to each discrete fluid spray site.

7. The spray head of claim 1, wherein said nozzle further comprises a spray shaping mechanism that defines directing electrodes positioned equidistant at opposite ends of said one or more fluid spray sites.

8. The spray head of claim 7, wherein said directing electrodes are charged at substantially the same polarity and voltage as said fluid spray sites.

9. The spray head of claim 7, wherein said spray shaping mechanism defines parallel counter electrodes.

10. The spray head of claim 9, wherein said counter electrodes comprise thin rods that are arranged in parallel with and straddle said one or more fluid spray sites.

11. The spray head of claim 10, wherein the combination of vertical and horizontal positioning of said parallel counter electrodes in relation to said fluid spray sites effectively provides for directional spraying and variations in the shape of said charged aerosol.

12. The spray head of claim 11, wherein said directional spraying provides for efficient and targeted application of a sprayable formulation while requiring less active ingredient.

13. The spray head of claim 1, wherein said shroud comprises a dielectric material.

14. The spray head of claim 13, wherein said dielectric material is polymeric.

15. The spray head of claim 13, wherein said dielectric material is transparent.

16. The spray head of claim 13, wherein said dielectric material is opaque.

17. The spray head of claim 13, wherein said dielectric material is pigmented.

18. The spray head of claim 1, wherein said shroud is configured to physically direct said charged aerosol towards a target.

19. The spray head of claim 1, wherein said shroud surrounds and extends beyond said nozzle, said shroud configured to partially shield said charged aerosol from environmental influences during application of said aerosol to a target.

20. The spray head of claim 19, wherein said shroud is configured to prevent said charged aerosol from effecting an area surrounding said target.

21. The spray head of claim 1 further comprising a sensor, said sensor configured to prevent said device from discharging said charged aerosol when positioned in a substantially upside down orientation.

22. The spray head of claim 1, wherein said shroud comprises a plurality of dielectric tines, said tines configured to separate surrounding vegetation from a target.

23. The spray head of claim 1 further comprising a wheel configured to translocate said device.

24. The spray head of claim 23, wherein said wheel is configured to control the distance of said nozzle from said target.

25. The spray head of claim 1, wherein said spray head is configured to rotate about one or more axes.

26. An electrohydrodynamic sprayer system comprising
a control panel;
a power source;
a pumping mechanism;
a fluid container; and
a spray head comprising
at least one nozzle configured to provide a charged aerosol from a liquid formulation, said nozzle comprising a manifold having at least one fluid entrance and one or more discrete fluid spray sites, and
a shroud that at least partially surrounds said nozzle.
